(19) United States
(12) Patent Application Publication
(10) Pub. No.: US 2026/0029014 A1
(43) Pub. Date: Jan. 29, 2026

(54) Double Arm Blind Hole Fastener

(71) Applicant: Illinois Tool Works Inc., Glenview, IL (US)

(72) Inventors: Harrison Sanders, Homewood, IL (US); Eric Kato, Naperville, IL (US); Lovisa Rodriguez, Frankfort, IL (US)

(21) Appl. No.: 19/269,960

(22) Filed: Jul. 15, 2025

Related U.S. Application Data
(60) Provisional application No. 63/674,884, filed on Jul. 24, 2024.

(51) Int. Cl. F16B 37/04

(52) U.S. Cl. CPC F16B 37/043; F16B 2200/99

(57) ABSTRACT

A fastener assembly designed to attach two components together by inserting it into an opening in the second component. The fastener assembly includes a fastener and a collar with two surfaces. Extending from one surface of the collar of the fastener assembly are two upper arms and two lower arms, each of which can flex inward during installation. When the fastener is fully inserted, the ends of the upper and lower arms within a pair make contact with each other to give the user a physical or audible indication that installation is complete.

### RELATED APPLICATION

The present application claims priority to U.S. Provisional Patent Application No. 63/674,884, filed Jul. 24, 2024, entitled “Double Arm Blind Hole Fastener,” which is hereby incorporated by reference in their entirety.

### BACKGROUND

Automotive components require fastening techniques that are simple to manufacture and assemble. Further, fastening techniques should above all be reliable and efficient. Blind hole fasteners are frequently used in applications where access is limited to one side of a workpiece, such as in vehicle interiors, electronics housings, or structural panels. These fasteners are designed to secure components into pre-formed holes without requiring access to the rear surface for installation or engagement.

However, challenges often arise in confirming whether a blind hole fastener has been properly seated or secured, particularly in environments where visual inspection is impractical or impossible. Improper installation may result in insufficient retention, unwanted movement, or long-term reliability issues under dynamic load or vibration.

Accordingly, there remains a need for blind hole fasteners that facilitate or enhance installation verification. In particular, there is a need for fasteners that can provide user-perceivable feedback—such as tactile feedback or audible feedback—during installation, to assist in confirming that full engagement has been achieved without requiring visual confirmation.

### SUMMARY

The present disclosure relates generally to a blind hole fastener, substantially as illustrated by and described in connection with at least one of the figures, as set forth more completely in the claims. More specifically, the present disclosure relates generally to a blind hole fastener that provides tactile feedback and/or audible feedback to verify installation.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an isometric assembly view of a fastener system including a blind fastener assembly, in accordance with an aspect of this disclosure.

FIG. 1b illustrates a side elevation view of the assembled fastener system, in accordance with an aspect of this disclosure.

FIG. 1c illustrates an isometric, partially assembled view of the blind fastener assembly.

FIG. 1d illustrates an isometric view of the fully assembled blind fastener assembly.

FIG. 2a illustrates a topside isometric view of the blind fastener assembly shown in FIGS. 1a through 1d, in accordance with an aspect of this disclosure.

FIG. 2b illustrates an underside isometric view of the blind fastener assembly.

FIGS. 2c and 2d illustrate, respectively, top and bottom plan views of the fastener assembly.

FIG. 2e illustrates a side elevation view of the fastener assembly, while FIG. 2f illustrates a side elevation view taken along cutline A-A in FIG. 2e.

FIG. 2g illustrates a side elevation view of the fastener assembly, while FIG. 2h illustrates a side elevation view taken along cutline B-B in FIG. 2g.

FIG. 3 illustrates an enlarged side elevation view (Detail A) of the verification arms of the fastener assembly.

FIGS. 4a and 4b illustrate enlarged side elevation views of verification arms in accordance with further aspects of this disclosure.

FIGS. 5a through 5f illustrate additional styles of fasteners suitable for coupling the carrier component with another component, in accordance with further aspects of this disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

In one example, a fastener assembly to couple a first component to a second component via an opening associated with the second component comprises: a fastener configured to secure with the second component via the opening; a collar coupled to the fastener and having a first surface and a second surface opposite the first surface; a pair of upper verification arms extending from the second surface of the collar, each upper verification arm having a proximal end and a distal end; and a pair of lower verification arms extending from the second surface of the collar, each lower verification arm having a proximal end and a distal end, wherein each of the pair of upper verification arms and the pair of lower verification arms are resiliently deflectable toward each other during insertion of the fastener into the opening, and wherein the distal ends of the upper and lower verification arms are configured to move toward and mechanically engage the distal ends of the upper verification arms one another to provide feedback to a user upon full insertion.

In an example, the feedback is tactile feedback.

In an example, the feedback is audible feedback.

In an example, the distal end of each lower verification arm includes a lip portion projecting toward the collar to define an L-shaped geometry.

In an example, a transition between a body portion of each lower verification arm and the lip portion is curved, squared, and/or chamfered.

In an example, the distal end of each upper verification arm is square-shaped.

In an example, the distal end of each upper verification arm is rounded.

In an example, each of the upper and lower verification arms are integrally formed with the collar.

In an example, each of the upper and lower verification arms extend outwardly from the second surface of the collar at first and second angles, respectively, relative to a plane defined by the second surface of the collar.

In an example, the first and second angles are each between about 25 degrees and about 65 degrees.

In an example, the first and second angles are each between about 40 degrees and about 50 degrees.

In an example, the lower verification arms are configured to engage a surface of the second component during insertion and to flex toward the upper verification arms.

In an example, engagement between the distal ends of each pair of upper verification arms and lower verification arms occurs adjacent a transition between a body portion of each lower verification arm and a lip portion in the lower verification arms.

In an example, the fastener assembly is a unitary plastic component.

In an example, the fastener assembly further comprises a second fastener oriented in an opposed direction relative to the fastener.

In an example, the second fastener includes a threaded shank.

In an example, the collar is positioned between the fastener and the second fastener.

In an example, the fastener and the second fastener are concentric.

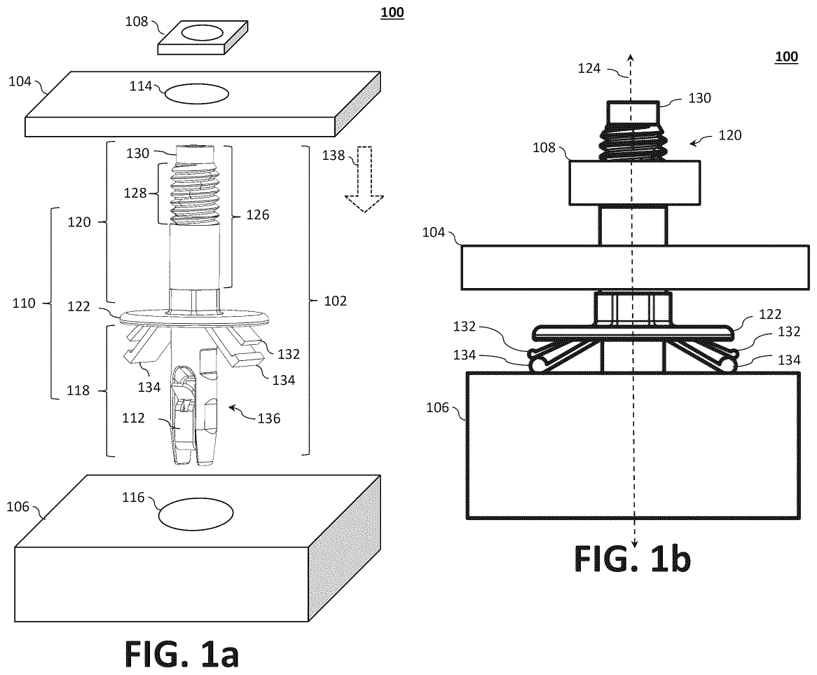

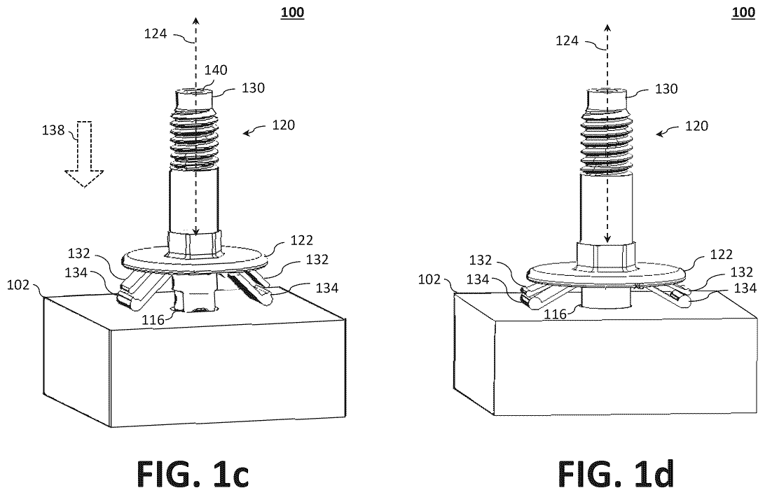

FIG. 1a illustrates an isometric assembly view of a fastener system 100 including a blind fastener assembly 102, in accordance with an aspect of this disclosure. FIG. 1b illustrates a side elevation view of the assembled fastener system 100, in accordance with an aspect of this disclosure, while FIG. 1c illustrates an isometric, partially assembled view of the blind fastener assembly 102 and FIG. 1d illustrates an isometric view of the fully assembled blind fastener assembly 102.

The illustrated fastener system 100 includes the blind fastener assembly 102, a first component 104, and a second component 106. The blind fastener assembly 102 is configured to join the first component 104 and the second component 106 via, for example, a nut 108 and/or one or more features formed in or on the first component 104 and the second component 106. In this example, the blind fastener assembly 102 generally comprises a double-ended fastener 110 and a clip 112. The double-ended fastener 110 comprises a first fastener 118, a second fastener 120, and a collar 122.

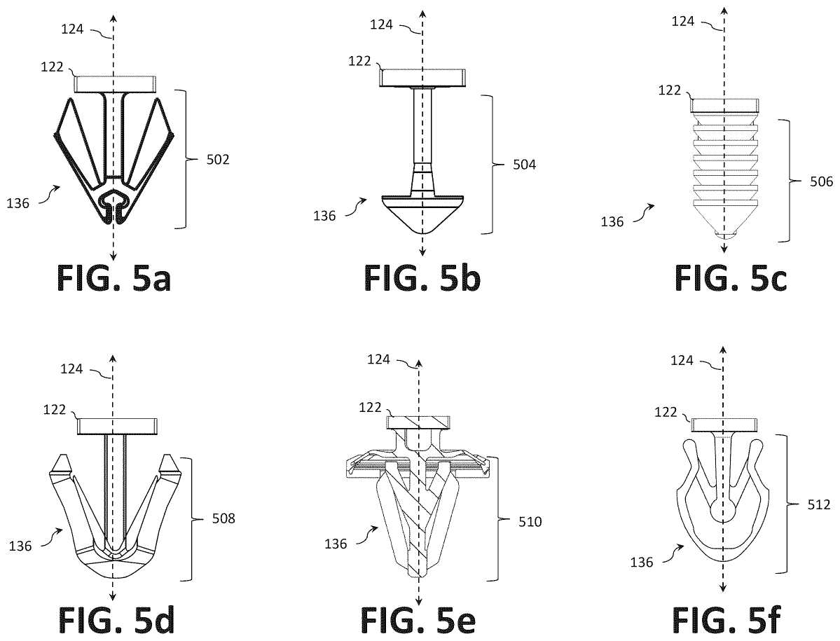

In the illustrated example, the first fastener 118 includes a fastener feature 136 that is plastic and cooperated with a clip 112 that is stamped metal, though other fastener features 136 are contemplated, including those described in connection with FIGS. 5a through 5f. The illustrated second fastener 120 is a shank that includes a head 130 that is tapered, a bore 140 that passes lengthwise along the second fastener 120, and threads 128 formed on at least a portion of the shank 126. The second fastener 120 is similar to the shank of a shoulder bolt in that only a portion of the shank 126 includes thread 128, but other configurations are contemplated.

As illustrated, each of the first component 104 and the second component 106 can include one or more engagement features that facilitate attachment with the blind fastener assembly 102. For example, the first component 104 is illustrated as having a first opening 114 formed therein, while the second component 106 is illustrated as having a second opening 116 formed thereon. The first opening 114 and/or second opening 116 can be formed in or on the first component 104 and/or the second component 106 during manufacturing thereof or added post-manufacture through a mechanical process (e.g., drilling, cutting, carving, etc.), or otherwise.

While FIG. 1a illustrates the fastener system 100 as being coupled to the first component 104 via the nut 108, other fastening techniques and arrangements are contemplated. For example, rather than a threaded nut 108, a friction-based fastener can be used (e.g., a clip, sleeve, etc.). In another example, the first opening 114 formed in the first component 104 can be threaded and configured to engage the second fastener 120 of the double-ended fastener 110, thus obviating the need for additional fasteners (e.g., nut 108).

After the first component 104 and the second component 106 are assembled, as best illustrated in FIG. 1b, the second component 106 can be covered at least partially by the first component 104. In some examples, one or both of the first component 104 and the second component 106 can include additional attachment features.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, spoilers, door trim panels, moldings, trim pieces, and other substrates (whether used as interior or exterior surfaces). The second component 106 may be, for example, a frame, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

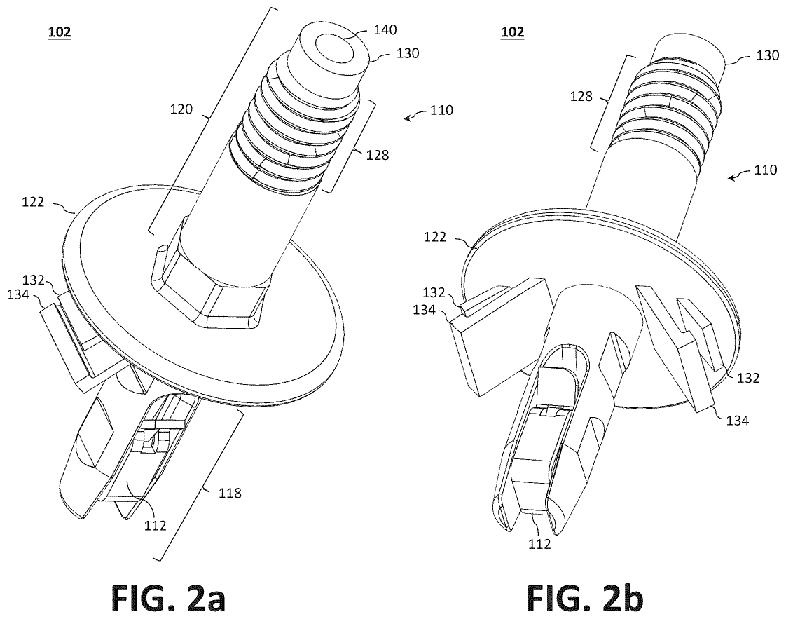

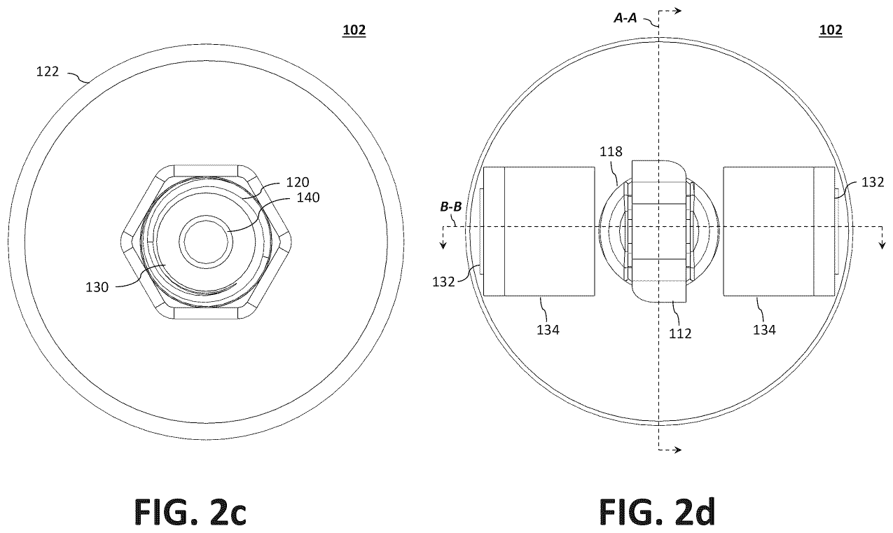

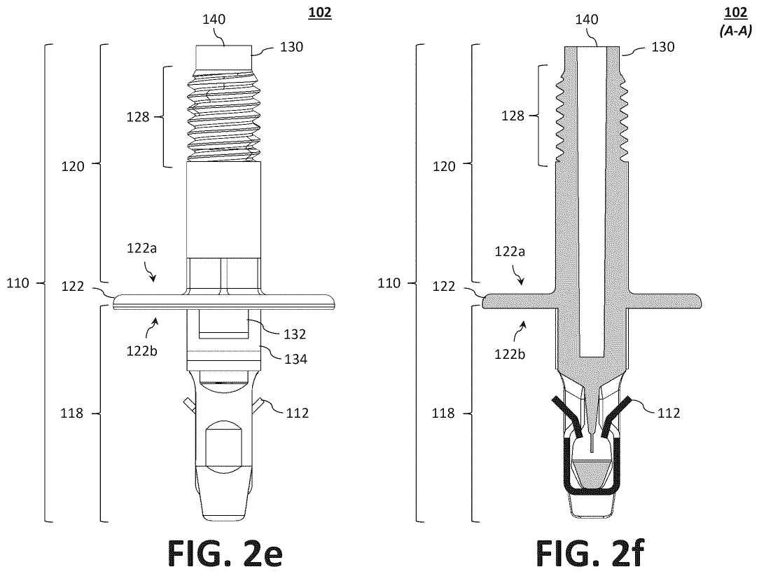

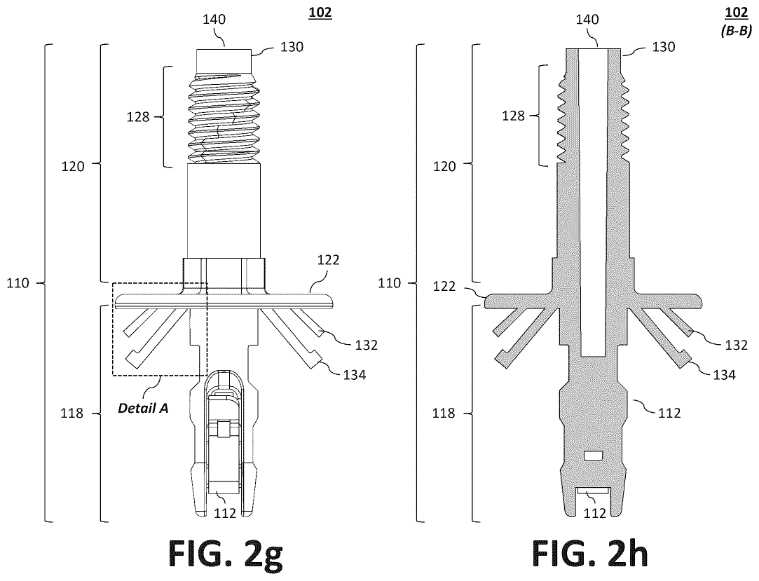

FIG. 2a illustrates a topside isometric view of the blind fastener assembly 102 shown in FIGS. 1a through 1d, in accordance with an aspect of this disclosure. FIG. 2b illustrates an underside isometric view of the blind fastener assembly 102, while FIGS. 2c and 2d illustrate, respectively, top and bottom plan views of the fastener assembly. FIG. 2e illustrates a side elevation view of the fastener assembly, while FIG. 2f illustrates a side elevation view taken along cutline A-A in FIG. 2e. FIG. 2g illustrates a side elevation view of the fastener assembly, while FIG. 2h illustrates a side elevation view taken along cutline B-B in FIG. 2g.

The illustrated double-ended fastener 110 comprises the first fastener 118 and the second fastener 120 oriented in opposed directions with the collar 122 positioned therebetween. In the illustrated example, the first fastener 118 and the second fastener 120 are aligned along the central axis 124 (e.g., generally coaxial). While the first fastener 118 of the double-ended fastener 110 is illustrated as shorter in length than the second fastener 120, in other examples the first fastener 118 can be the same length or longer than the second fastener 120. The second fastener 120 can each define one or more threads 128, which are configured to engage one of the nut 108 (or other type of female fastener). The first fastener 118 can cooperate with the clip 112 to engage and secure with the second component 106 via the second opening 116.

The collar 122 (e.g., platform or plate) is positioned between the first fastener 118 and the second fastener 120. In the illustrated example, the collar 122 is a generally annular plate that defines a first surface 122a and a second surface 122b. Each of the illustrated first surface 122a and second surface 122b is planar. The illustrated first surface 122a is oriented to face or abut the first component 104, while the illustrated second surface 122b is oriented to face or abut the second component 106.

As noted, it is desirable to provide tactile feedback and/or audible feedback to verify installation during assembly of the double-ended fastener 110 with the second opening 116 of the second component 106. Accordingly, double-ended fastener 110 comprises a plurality of upper and lower verification arms 132, 134 that cooperated with one another to provide tactile feedback and/or audible feedback to the user.

The illustrated plurality of verification arms comprises a pair of upper verification arms 132 (e.g., a pair of first verification arms) and a pair of lower verification arms 134 (e.g., a pair of second verification arms). Each of the upper and lower verification arms 132 and 134 is angled outwardly relative to a central axis 124 of the fastener assembly. In some embodiments, each of the lower verification arms 134 has a greater width than each of the upper verification arms 132.

In the illustrated example, an upper verification arm 132 and a lower verification arm 134 are positioned on opposite sides of the central axis 124—that is, a set of upper and lower verification arms 132, 134 are positioned on each side of the central axis 124. While two upper verification arms 132 and two lower verification arms 134 are illustrated, additional, or fewer verification arms 132, 134 can be employed. For example, three or more sets of upper and lower verification arms 132, 134 can be employed and distributed (E.g., evenly distributed) about the central axis 124.

It is contemplated that certain components of the blind fastener assembly 102 may be fabricated from plastic, metal, or a combination thereof. The double-ended fastener 110 can be fabricated from a plastic material using a plastic injection technique, additive manufacturing, or otherwise. It is contemplated, however, that the double-ended fastener 110 and/or the clip 112 could also be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In some examples, the double-ended fastener 110 (e.g., a portion thereof), clip 112, and nut 108, for example, can be fabricated from metal using, for example, a metal-drawing or other metal-forming technique. By way of example, one or more of the double-ended fastener 110, clip 112, and nut 108 can be fabricated using a metal-stamping technique or a cold metal forming technique, where threading is added via a thread rolling or tapping technique. The metal components can be heat treated to enhance strength and hardness.

In some examples, a seal may be provided to mitigate ingress of liquid and/or debris through the first opening 114 or the second opening 116. The seal may be fabricated from a foam material, thermoplastic, rubber, etc. For example, the seal can be configured to surround a portion of the double-ended fastener 110 (e.g., the second fastener 120. The seal can be, for example, formed on a surface of the collar 122 (e.g., the surface that abuts the first component 104).

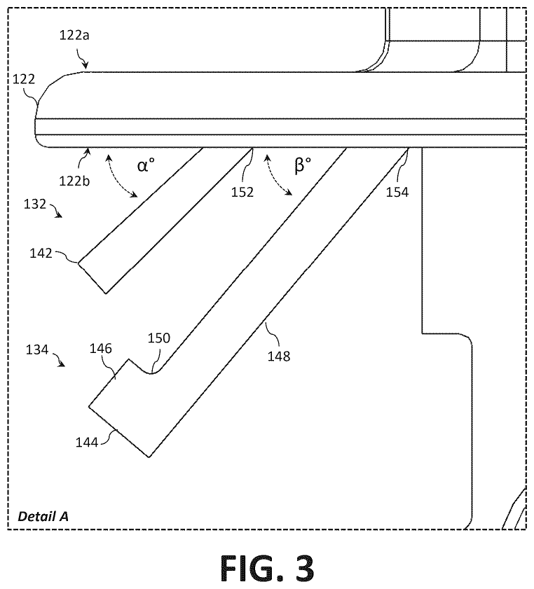

FIG. 3 illustrates an enlarged side elevation view (Detail A) of the upper and lower verification arms 132 and 134 of the fastener assembly. In the illustrated embodiment, the plurality of upper and lower verification arms 132 and 134 are resiliently coupled to a second surface 122b of the collar 122. In certain embodiments, the verification arms 132 and 134 may be integrally formed with the double-ended fastener 110 (e.g., with the collar 122) to facilitate ease of manufacturing and assembly.

Each upper verification arm 132 is generally planar and is resiliently coupled to the second surface 122b of the collar 122 at a proximal end 152. A distal end 142 of the upper verification arm 132 extends outwardly at an angle relative to the central axis 124 and the second surface 122b. In the illustrated example, the side profile of the distal end 142 includes two right angles, forming a generally square-ended configuration.

Each lower verification arm 134 is also generally planar and is resiliently coupled to the second surface 122b of the collar 122 at a proximal end 154. A distal end 144 of the lower verification arm 134 extends outwardly at an angle relative to the central axis 124 and the second surface 122b. In the illustrated embodiment, the distal end 144 includes a raised lip portion 146 extending along a width of a body portion 148. The lip portion 146 projects away from the body portion 148 and toward the upper verification arms 132 and/or the collar 122, forming a generally L-shaped geometry. The side profile of the distal end 144 includes three right angles, with a curved transition 150 between the body portion 148 and the lip portion 146.

In a pre-installed (i.e., relaxed) state, each upper verification arm 132 is arranged at a first angle α° relative to the second surface 122b of the collar 122, and each lower verification arm 134 is arranged at a second angle β° relative to the second surface 122b. In some embodiments, the first angle α° and the second angle β° are substantially the same. However, the angles may be different to tailor a desired tactile and/or audible feedback response. For example, the first angle α° may range from approximately 25° to approximately 65°, from approximately 40° to approximately 50°, or be approximately 45°, and the second angle β° may also range from approximately 25° to approximately 65°, from approximately 40° to approximately 50°, or be approximately 45°.

During assembly, the lower verification arms 134 first engage a surface of a second component 106 (as shown, for example, in FIG. 1c). As the blind fastener assembly 102 is advanced along an insertion direction indicated by arrow 138 and into the second opening 116, the lower verification arms 134 deflect inwardly toward the upper verification arms 132.

Upon full insertion or assembly, the distal ends 142 of the upper verification arms 132 engage the distal ends 144 of the lower verification arms 134, such as at or near the interior bend of the L-shaped lower verification arms (e.g., at the transition 150). The mechanical interaction between the distal ends 142 and 144 produces a tactile and/or audible feedback response, thereby providing confirmation of proper installation.

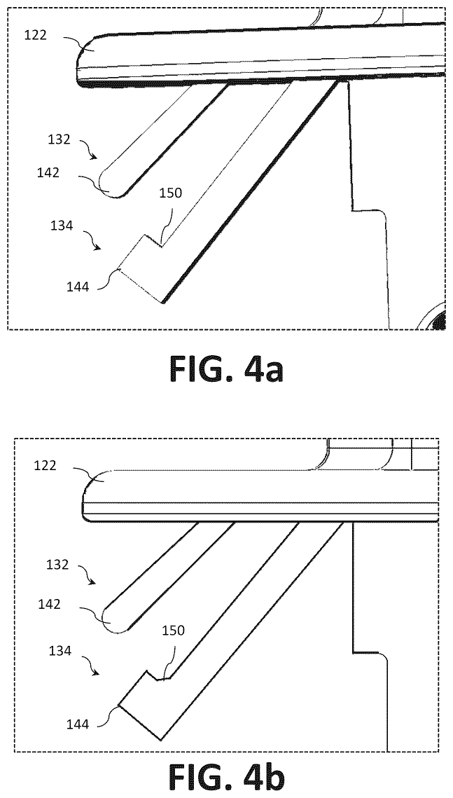

The shape of the distal ends 142 and 144 may be varied depending on the material properties and the desired characteristics of the feedback (e.g., strength, sharpness, or sound). FIGS. 4a and 4b illustrate alternate geometries of upper and lower verification arms 132 and 134 in accordance with further aspects of the present disclosure.

Referring to FIG. 4a, the upper verification arms 132 remain generally planar, but in this example, the distal ends 142 have a rounded profile (e.g., a half-circle shape). The lower verification arms 134 similarly remain generally planar, but the distal ends 144 include four right angles, with a squared transition 150 between the body portion 148 and lip portion 146.

Referring to FIG. 4b, the distal ends 142 of the upper verification arms 132 are again rounded. In this embodiment, the distal ends 144 of the lower verification arms 134 include three right angles, with a chamfered transition 150 between the body portion 148 and the lip portion 146 (e.g., an L-shaped profile with a beveled interior corner). These variations may provide differing feedback characteristics during engagement, depending on application requirements.

While the fastener feature 136 is illustrated in the figures with a particular fastener design, other fastener designs are contemplated. For example, FIGS. 5a through 5f illustrate additional styles of fastener features 136 suitable for coupling the fastener 136 with the second component 104 in accordance with other aspects of this disclosure. Specifically, FIGS. 5a through 5f illustrate, respectively, a W-shaped clip fastener 502 (illustrated as a 2-legged clip fastener), pin fastener 504, a push-pin fastener 506 (illustrated as a 2-legged box-prong fastener), a specialty clip assembly 508 (e.g., a CenterLok™ fastener, which is available from Deltar®), a clip assembly with four retaining legs 510, and a clip assembly with two snap-engaging seats 512. The clip assembly with four retaining legs 510, which is illustrated in FIG. 5e as a cross-sectional view, is further described in connection with commonly owned U.S. Pat. No. 10,385,901 to Jeffrey J. Steltz. The clip assembly with two snap-engaging seats of FIG. 5f is further described in connection with commonly owned U.S. Pat. No. 10,018,214 to Fulvio Pacifico Yon.

The above-cited patents and patent publications are hereby incorporated by reference in their entirety. While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fastener assembly to couple a first component to a second component via an opening associated with the second component, the fastener assembly comprising:
a fastener configured to secure with the second component via the opening;
a collar coupled to the fastener and having a first surface and a second surface opposite the first surface;
a pair of upper verification arms extending from the second surface of the collar, each upper verification arm having a proximal end and a distal end; and
a pair of lower verification arms extending from the second surface of the collar, each lower verification arm having a proximal end and a distal end,
wherein each of the pair of upper verification arms and the pair of lower verification arms are resiliently deflectable during insertion of the fastener into the opening, and
wherein the distal ends of the lower verification arms are configured to move toward and mechanically engage the distal ends of the upper verification arms to provide feedback to a user upon full insertion.

2. The fastener assembly of claim 1, wherein the feedback is tactile feedback.

3. The fastener assembly of claim 1, wherein the feedback is audible feedback.

4. The fastener assembly of claim 1, wherein the distal end of each lower verification arm includes a lip portion projecting toward the collar to define an L-shaped geometry.

5. The fastener assembly of claim 4, wherein a transition between a body portion of each lower verification arm and the lip portion is curved.

6. The fastener assembly of claim 4, wherein a transition between a body portion of each lower verification arm and the lip portion is squared.

7. The fastener assembly of claim 4, wherein a transition between a body portion of each lower verification arm and the lip portion is chamfered.

8. The fastener assembly of claim 1, wherein the distal end of each upper verification arm is square-shaped.

9. The fastener assembly of claim 1, wherein the distal end of each upper verification arm is rounded.

10. The fastener assembly of claim 1, wherein each of the upper and lower verification arms are integrally formed with the collar.

11. The fastener assembly of claim 1, wherein each of the upper and lower verification arms extend outwardly from the second surface of the collar at first and second angles, respectively, relative to a plane defined by the second surface of the collar.

12. The fastener assembly of claim 11, wherein the first and second angles are each between about 25 degrees and about 65 degrees.

13. The fastener assembly of claim 11, wherein the first and second angles are each between about 40 degrees and about 50 degrees.

14. The fastener assembly of claim 1, wherein the lower verification arms are configured to engage a surface of the second component during insertion and to flex toward the upper verification arms.

15. The fastener assembly of claim 1, wherein engagement between the distal ends of each pair of upper verification arms and lower verification arms occurs adjacent a transition between a body portion of each lower verification arm and a lip portion in the lower verification arms.

16. The fastener assembly of claim 1, wherein the fastener assembly is a unitary plastic component.

17. The fastener assembly of claim 1, wherein the fastener assembly further comprises a second fastener oriented in an opposed direction relative to the fastener.

18. The fastener assembly of claim 17, wherein the second fastener includes a threaded shank.

19. The fastener assembly of claim 17, wherein the collar is positioned between the fastener and the second fastener.

20. The fastener assembly of claim 17, wherein the fastener and the second fastener are concentric.
